(19) United States
(12) Patent Application Publication
(10) Pub. No.: US 2024/0109544 A1
(43) Pub. Date: Apr. 4, 2024

(54) METHOD AND DEVICE FOR COLLISION PREDICTING

(71) Applicant: Mobile Drive Technology Co., Ltd., New Taipei (TW)

(72) Inventors: CHIEN-HUNG YU, New Taipei (TW); WEI-JIE CHEN, New Taipei (TW)

(21) Appl. No.: 18/081,562

(22) Filed: Dec. 14, 2022

(30) Foreign Application Priority Data
Sep. 30, 2022 (TW) 111137444

(51) Int. Cl. B60W 40/10; B60W 50/14

(52) U.S. Cl. CPC B60W 40/10; B60W 50/14; B60W 2050/143; B60W 2050/146; B60W 2520/00; B60W 2554/4041; B60W 2554/80

(57) ABSTRACT

A method and device for collision predicting and readable computer storage medium. The method for collision predicting includes: obtaining a host vehicle motion track of a host vehicle; obtaining at least one host vehicle track point on the host vehicle motion track; establishing a collision prediction area around the host vehicle track point, and matching the collision prediction area to a time point where the host vehicle is located at the host vehicle track point; obtaining a target vehicle motion track of a target vehicle; obtaining at least one target vehicle track point on the target vehicle motion track, and matching the target vehicle track point to a time point where the target vehicle is located at the target vehicle track point; and calculating a projected collision time between the host vehicle and the target vehicle when a preset condition is met.

### FIELD

The present disclosure relates to the field of intelligent driving technology, in particular to a collision predicting method and device.

### BACKGROUND

The collision warning function may be limited to specific impact areas in front of or behind the vehicle. For example, during vehicle driving, the collision warning function of the host vehicle monitors the dynamics of vehicles in front of or behind the host vehicle and monitors the driving dynamics of the host vehicle to give collision warning in front of or behind the host vehicle. The collision warning system may ignore vehicles in other locations, so there are great limitations in such collision warning systems, and achieving a warning of all possible collisions may be problematic.

Therefore, improvement is desired.

### SUMMARY

The embodiment of the present disclosure aims to provide a method for predicting collisions and device, the present disclosure discloses a comprehensive system of collision warning.

The disclosure provides a collision predicting method, including: obtaining a host vehicle motion track of a host vehicle; obtaining at least one host vehicle track point on the host vehicle motion track; establishing a collision prediction area around the at least one host vehicle track point, and matching the collision prediction area to a time point where the host vehicle is projected to be at the at least one host vehicle track point; obtaining a target vehicle motion track of a target vehicle; obtaining at least one target vehicle track point on the target vehicle motion track, and matching the at least one target vehicle track point to a time point where the target vehicle is projected to be at the at least one target vehicle track point; and calculating a projected collision time between the host vehicle and the target vehicle when a preset condition is met; wherein the preset condition is an overlap of the target vehicle motion track and the collision prediction area.

According to one embodiment of the present disclosure, the preset condition further includes the time point of the at least one target vehicle track point being the same as the time point of the collision prediction area, and the target vehicle track point is located in the collision prediction area.

According to one embodiment of the present disclosure, wherein calculating a projected collision time between the host vehicle and the target vehicle comprises: setting an independent coordinate; wherein a direction from the at least one host vehicle track point to the target vehicle track point is a vertical axis direction of the independent coordinate; obtaining a relative longitudinal distance between the at least one target vehicle track point and the at least one host vehicle track point according to the independent coordinate; obtaining a relative longitudinal velocity of the target vehicle at the target track point and the host vehicle at the host vehicle track point according to the independent coordinate; and calculating the projected collision time according to the relative longitudinal distance and the relative longitudinal velocity.

According to one embodiment of the present disclosure, obtaining a host vehicle motion track of a host vehicle includes: obtaining first information as to dynamics of the host vehicle and inputting the first information to a lane change track model when the host vehicle changes lanes, to obtain the host vehicle motion track.

According to one embodiment of the present disclosure, the first information comprises a velocity of the host vehicle, an acceleration of the host vehicle; and a jerk (i.e. acceleration change rate) of the host vehicle, a formula of the lane change track model includes:

$${y}_{TAP} ( t ) = \{ \begin{matrix}\frac{1}{6} {J}_{y , d} {t}^{3} , for 0 \leq t \leq {t}_{1} \\ {y}_{1} + {v}_{1} ( t - {t}_{1} ) + \frac{1}{2} {{a}_{y , d} ( t - {t}_{1} )}^{2} , for {t}_{1} < t \leq {t}_{2} \\ {y}_{2} + {v}_{2} ( t - {t}_{2} ) + \frac{1}{2} {{a}_{y , 2 , d} ( t - {t}_{2} )}^{2} + \frac{1}{6} ( - {J}_{y , d} ) {( t - {t}_{2} )}^{3} , for {t}_{2} < t \leq {t}_{3} \\ {y}_{3} + {v}_{3} ( t - {t}_{3} ) + \frac{1}{2} ( - {a}_{y , d} ) {( t - {t}_{3} )}^{2} + \frac{1}{6} {{J}_{y , d} ( t - {t}_{3} )}^{3} , for {t}_{3} < t \leq {t}_{4} \\ {y}_{4} + {v}_{4} ( t - {t}_{4} ) + \frac{1}{2} ( - {a}_{y , d} ) {( t - {t}_{4} )}^{2} , for {t}_{4} < t \leq {t}_{5} \\ {y}_{5} + {v}_{5} ( t - {t}_{5} ) + \frac{1}{6} ( - {J}_{y , d} ) {( t - {t}_{5} )}^{3} , for {t}_{5} < t \leq {t}_{6} \\ {y}_{e v a} , for t > {t}_{6}\end{matrix} {x}_{TAP} ( t ) = v t$$

wherein y_{TAP}(t) is a horizontal coordinate with the host vehicle is a point of origin during lane change; x_{TAP}(t) is a longitudinal coordinate; Jᵢ(t) is a jerk (i.e. lateral acceleration change rate) of the host vehicle, aᵢ(t) is an acceleration of the host vehicle, yᵢ(t) is a lateral distance at time tᵢ, vᵢ is velocity at time tᵢ, yₑᵥₐ is a total lateral distance of the lane change; v is a longitudinal velocity of the host vehicle, and t is the time point. The term lateral can include driving across a roadway to a different driving lane.

According to one possible embodiment of the present disclosure, the obtaining of a target vehicle motion track of a target vehicle includes: obtaining a second information as to dynamics of the target vehicle and inputting the second information to a target vehicle track model to obtain the target vehicle motion track.

According to one embodiment of the present disclosure, the second information comprises a velocity of the target vehicle, and an acceleration of the target vehicle, a formula of the target vehicle track model includes:

$$[ \begin{matrix}{\hat{X}}_{k + 1} \\ {\hat{Y}}_{k + 1} \\ {\hat{V}}_{x , k + 1} \\ {\hat{V}}_{y , k + 1} \\ {\hat{a}}_{x , k + 1}\end{matrix} ] = [ \begin{matrix}1 & 0 & T & 0 & 0.5 {T}^{2} \\ 0 & 1 & 0 & T & 0 \\ 0 & 0 & 1 & 0 & T \\ 0 & 0 & 0 & 1 & 0 \\ 0 & 0 & 0 & 0 & 1\end{matrix} ] [ \begin{matrix}{\hat{X}}_{k} \\ {\hat{Y}}_{k} \\ {\hat{V}}_{x , k} \\ {\hat{V}}_{y , k} \\ {\hat{a}}_{x , k}\end{matrix} ]$$

wherein \hat{X}ₖ is a horizontal coordinate at a time k, Ŷₖ is a longitudinal coordinate at the time k, \hat{V}_{y,k} is a longitudinal velocity at the time k, â_{x,k} is a lateral acceleration at time k, T is a time point, \hat{X}ₖ₊₁ is the horizontal coordinate at a time k+1, Ŷₖ₊₁ is the longitudinal coordinate at the time k+1, \hat{V}_{x,k+1} is a lateral velocity at the time k+1, \hat{V}_{y,k+1} is the longitudinal velocity at the time k+1, and â_{x,k+1} is the lateral acceleration at the time k+1.

According to one embodiment of the present disclosure, the method further includes: warning as to the collision prediction area when the projected collision time is less than a preset threshold value.

The disclosure provides a device predicting collisions and includes:
a host vehicle track obtaining module configured for obtaining a host vehicle motion track of a host vehicle;
a track point obtaining module configured for obtaining at least one host vehicle track point on the host vehicle motion track;
a prediction area establishing module configured for establishing an area where a collision is predicted around the host vehicle track point, and matching the collision prediction area to a time point where the host vehicle will be located at the host vehicle track point;
a target vehicle track obtaining module configured for obtaining a target vehicle motion track of a target vehicle;
a second track point obtaining module configured for obtaining at least one target vehicle track point on the target vehicle motion track, and matching the target vehicle track point to a time point where the target vehicle will be located at the target vehicle track point; and
a projected collision time calculating module configured for calculating the time of a future collision between the host vehicle and the target vehicle when a preset condition is met; wherein the preset condition is an overlap existing in the target vehicle motion track and the collision prediction area.

The present disclosure further provides a computer-readable storage medium, which stores a computer program. When the computer program is executed by a processor, the processor executes the method.

The beneficial effects of the technical solution provided by the disclosure include: the calculation of a projected collision time of a target vehicle around the host vehicle improves the comprehensiveness of the collision warning by obtaining the motion track of the host vehicle and the motion track of the target vehicle, so as to maximize the issue of warnings as to possible collisions.

### BRIEF DESCRIPTION OF THE DRAWINGS

FIG. 1 is a schematic diagram of a road traffic scene according to an embodiment of the present disclosure.

FIG. 2 is a flowchart of a method for predicting collisions according to an embodiment of the present disclosure.

FIG. 3 is a flowchart of a method for calculating time point of projected collision according to an embodiment of the present disclosure.

FIG. 4 is a schematic diagram of spatial relationship between vehicles being driven according to an embodiment of the present disclosure.

FIG. 5 is a flowchart of a collision predicting method according to an embodiment of the present disclosure.

FIG. 6 is a schematic diagram of a collision predicting device according to an embodiment of the present disclosure.

### DETAILED DESCRIPTION

It should be noted that “at least one” in the implementation mode of the disclosure refers to one or more, and “multiple” refers to two or more. “And/or”, which describes the association between objects, indicates that there can be three kinds of relationships, for example, A and/or B can indicate: that A exists alone, that A and B exist simultaneously, and that B exists alone, where A and B can be singular or plural. The terms “first”, “second”, “third”, “fourth” in the description, claims and illustrations of this disclosure are used to distinguish similar objects, not to describe a specific order or sequence.

It should be noted that the method disclosed in the embodiment or the method shown in the flowchart includes one or more steps for implementing the method. Without departing from the scope of the claims, the execution order of the multiple steps can be interchanged with each other, and some steps can also be deleted.

The embodiments of the present disclosure are described in detail below in combination with the accompanying drawings.

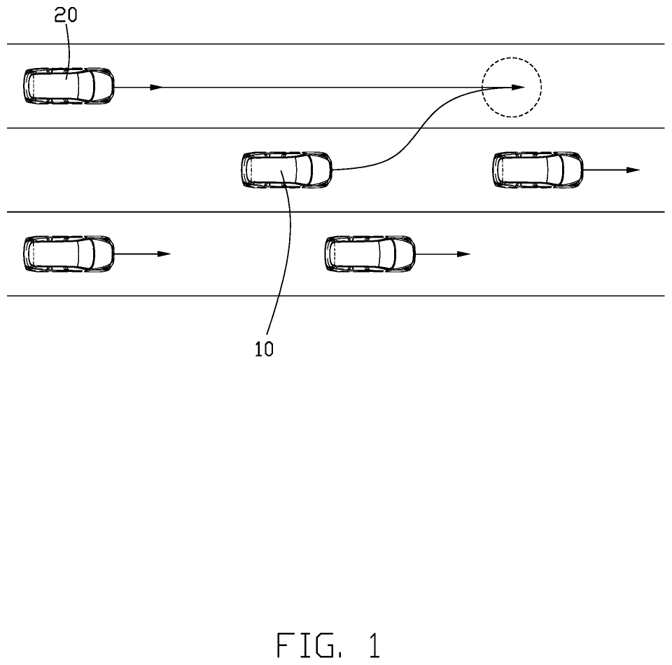

FIG. 1 illustrates several vehicles driving on a roadway in accordance with an embodiment of the present disclosure.

FIG. 1 specifically shows the host vehicle 10 and the target vehicle 20 on the adjacent lane. In relevant technologies, the host vehicle 10 and/or the target vehicle 20 may be equipped with a driving assistance system, which can alert a vehicle as to possible collisions in front or behind the vehicle through the collision warning function in the driving assistance system. In relevant technologies, the collision warning function is limited to specific areas directly in front of or behind the vehicle. For example, in the vehicle driving scenario in FIG. 1, the collision warning function of the host vehicle 10 will only monitor the dynamics of the vehicles in front of or behind the host vehicle 10, and the driving dynamics of the host vehicle 10, to give collision warning relevant to the direct front or the direct rear of the host vehicle 10. The target vehicle 20 on the side adjacent to the middle lane and in an oblique relation to host vehicle 10, is completely ignored in the existing collision warning function, so the collision warning function of the host vehicle 10 has great limitations.

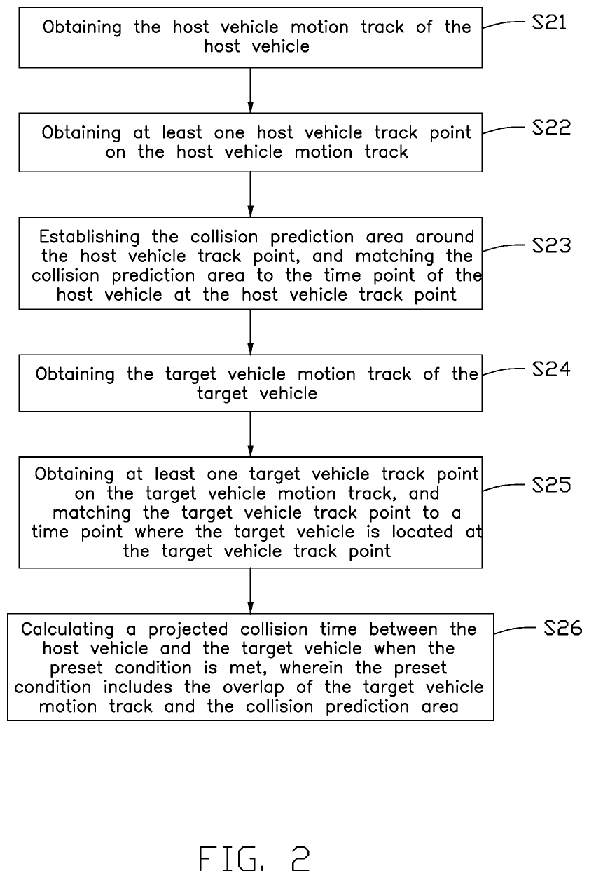

A collision predicting method provided by the embodiment of the disclosure is described in relation to FIG. 1. FIG. 2 is a flowchart of a collision predicting method according to an embodiment of the present disclosure, the collision predicting method includes the following steps:

At step S21, obtaining the host vehicle motion track of the host vehicle.

In the embodiment, when the host vehicle is driving on the middle lane, the host vehicle can obtain the motion track ahead of it in real time, the motion track includes the motion track planned by the host vehicle, or the motion track predicted.

As an optional embodiment, for automatic driving, the on-board computer of the host vehicle can obtain data through a full range of sensors, and then analyze the distribution of surrounding vehicles and lane conditions. After analyzing the distribution, the on-board computer can actively plan the motion track. The surrounding vehicles include target vehicles in front of and behind the middle driving lane, and the target vehicles in the two lanes adjacent to the middle lane.

As an optional embodiment, for manual driving, the on-board computer of the host vehicle can obtain the inertial navigation data of the host vehicle through the inertial navigation sensor and obtain the historical host vehicle motion track according to the inertial navigation data. The on-board computer of the host vehicle also obtains the current driving data of the host vehicle, and according to the driving data and the historical motion track, obtains the motion track for prediction.

At step S22, obtaining at least one host vehicle track point on the host vehicle motion track.

In the embodiment, the host vehicle track points on the host vehicle motion track can be obtained according to the interval between specific points or events, the host vehicle motion track can be sampled for data points, so as to reduce the amount of calculation of the subsequent steps, reduce calculation overloading of the on-board computer, and reduce the computing requirements for calculations by the on-board computer.

As an optional embodiment, the multiple host vehicle track points can be sampled from the host vehicle motion track according to a preset time interval, in the multiple host vehicle track points, the time interval between adjacent or sequential track points of the host vehicle is a specific time value.

As an optional embodiment, the multiple host vehicle track points can be sampled from the host vehicle motion track according to the preset moving distance interval, and in the multiple host vehicle track points, the distance interval between two adjacent host vehicle track points is a specific distance value.

At step S23, the collision prediction area around the host vehicle track point is established, and the collision prediction area is matched with the time point of the host vehicle at the host vehicle track point.

The disclosure applies the center of each host vehicle track point to establish the collision prediction area of each host vehicle track point. The time points to each collision prediction area are assigned, the time of each collision prediction area being consistent with the time of the corresponding host vehicle track point.

As an optional embodiment, the shape and size of the collision prediction area can be preset, for example, the shape of the collision prediction area can be circular, elliptical, rectangular. The center point of the collision prediction area is the above host vehicle track point. The size includes a first size of the front and rear of the host vehicle track point, and a second size around the host vehicle track point includes the left and right sides. The on-board computer of the host vehicle plans the collision prediction area of each host vehicle track point according to the above shape and size information.

As an optional embodiment, there is a basic setting for the shape and size of the collision prediction area, which actively reduces the scope of the range when lane changes take place. For example, when the host vehicle is driving in the leftmost lane, there is no adjacent lane on the left side, and a collision prediction area beyond the left lane line can be ignored to obtain a target collision prediction area. The calculation amount of the subsequent steps is further reduced by ignoring a collision prediction area that is redundant and which will not participate in the subsequent steps, so as to reduce the pressure of calculations on the on-board computer and reduce the requirements for the calculation force of the on-board computer.

At step S24, obtaining the target vehicle motion track of the target vehicle.

The host vehicle will also obtain the target vehicle motion track of the target vehicle within the range of the full range sensor, the target vehicle includes the target vehicle in front of and behind the driving lane of the host vehicle, and the target vehicle in the one or two adjacent lanes.

As an optional embodiment, the on-board computer of the host vehicle can obtain the data of the target vehicle through full range sensing by the sensor. Such data includes the distance between the host vehicle and the target vehicle, the velocity of the target vehicle, the acceleration of the target vehicle, and the heading angle of the target vehicle.

As an optional embodiment, the target vehicle motion track is the future motion track of the target vehicle. After obtaining data from the sensor as to the target vehicle, the on-board computer of the host vehicle can input the data into a preset prediction calculation model to obtain the target vehicle motion track of the target vehicle.

At step S25, obtaining at least one target vehicle track point on the target vehicle motion track, and matching the target vehicle track point with a time point where the target vehicle will be located at the target vehicle track point.

The target vehicle track points on the target vehicle motion track can be obtained according to the specific information interval, the present disclosure can sample the data points on the target vehicle motion track, so as to reduce the amount of calculation of subsequent steps, reduce the calculation pressure of the on-board computer, and reduce the requirements for the on-board computer.

As an optional embodiment, the multiple target vehicle track points can be sampled from the target vehicle motion track according to the preset time interval, in the multiple target vehicle track points, the time interval between two adjacent target vehicle track points is a specific time value.

As an optional embodiment, the multiple target vehicle track points can be sampled from the target vehicle motion track according to the preset moving distance interval, in the multiple target vehicle track points, the distance interval between two adjacent target vehicle track points is a specific distance value.

As an optional embodiment, the time point of the target vehicle track point can be matched with the time point of the host vehicle track point and can also be matched with the time point of the collision prediction area.

As an optional embodiment, the time interval used for the sampling and the moving distance interval can be consistent between the host vehicle track point and the target vehicle track point.

As an optional embodiment, the time point of the target vehicle track point can be consistent with the time point of the host vehicle track point.

At step S26, calculating the projected collision time between the host vehicle and the target vehicle when the preset condition is met, wherein the preset condition includes an overlapping of the target vehicle motion track and the collision prediction area.

In the embodiment, the preset condition further includes the time point of the target vehicle track point being the same as the time point of the collision prediction area, and the target vehicle track point being located in the collision prediction area. The on-board computer of the host vehicle can calculate the projected collision time of the host vehicle and the target vehicle at the target time point after determining that the target vehicle track point is within the collision prediction area through a relatively simple determination process, so as to reduce the calculation amount of the on-board computer and improve the calculation speed.

As an optional embodiment, the above projected collision time is time to collision (TTC). Assuming that the collision prediction area where the above overlapping occurs includes a first target vehicle track point and a first host vehicle track point, inputting the first target vehicle track point and the first host vehicle track point to a projected collision time calculation module to obtain the projected collision time of the host vehicle and the target vehicle. The first target vehicle track point includes the velocity, acceleration and coordinate of the target vehicle, and the first host vehicle track point includes the velocity, acceleration and coordinate of the host vehicle.

As an optional embodiment, the present disclosure can give warning of a predicted collision according to the projected collision time.

As an optional embodiment, after calculating the above projected collision time, the on-board computer of the host vehicle will obtain the matching collision prediction results according to the projected collision time and display the results through the display device and the voice device. For example, the display device can display a warning in a highlighted color, or display the location of the target vehicles around the host vehicle in the display device and display the collision prediction results relating to each target vehicle.

As an optional embodiment, after calculating the above projected collision time, the collision prediction results can also be provided for automatic driving mode or manual driving as a reference for risk assessment.

The present disclosure can calculate and warn as to projected collision time of the target vehicle around the host vehicle by obtaining the motion track of the host vehicle and the motion track of the target vehicle, which can greatly improve the comprehensiveness of the collision warning, so as to maximize the warning of possible collisions. The present disclosure can also greatly reduce the amount of calculation for collision prediction between the host vehicle and surrounding target vehicles by obtaining the host vehicle track point, the collision prediction area, and the target vehicle track point, so as to make the collision prediction almost instantaneous and more accurate.

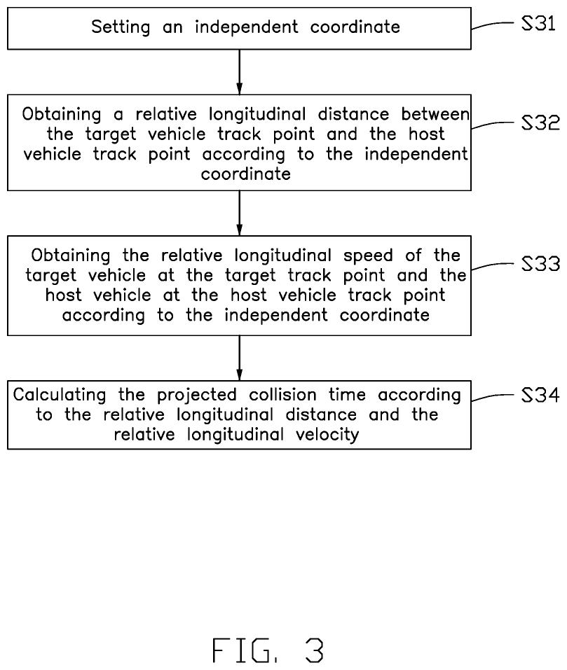

FIG. 3 illustrates a flowchart of a method for calculating the projected collision time according to the embodiment of the present disclosure, which is one of the above steps S26, and specifically includes the following steps:

At step S31, setting an independent coordinate.

The direction from the host vehicle track point to the target vehicle track point is the vertical axis direction of the independent coordinate.

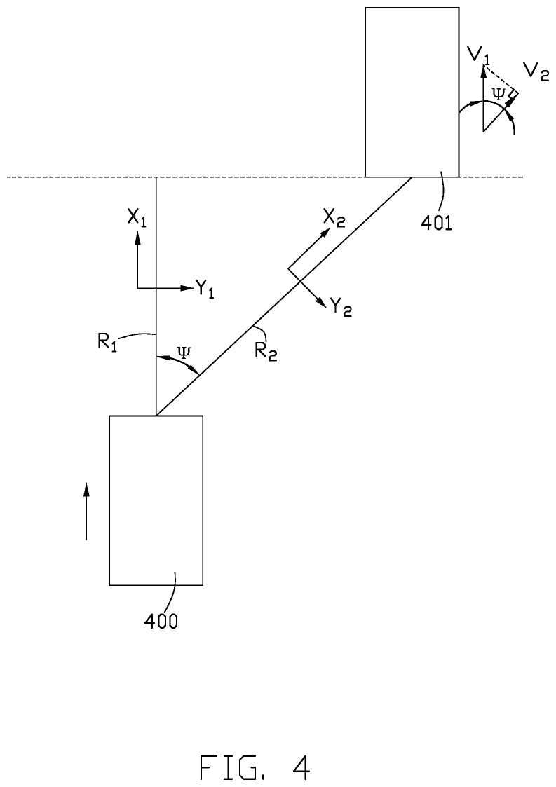

As shown in FIG. 4, the vehicle driving scene can include the host vehicle 400 and the target vehicle 401. X₁Y₁ is the standard coordinate based on the lane, and X₂Y₂ is the above independent coordinate. The vertical axis direction X₁ of the standard coordinate is the same as the driving direction of the host vehicle 400. The origin of the above independent coordinates can be the host vehicle track point, the horizontal and vertical axes coordinate being perpendicular to each other on a horizontal plane. The vertical axis direction X₂ is the direction of gradual approach between the host vehicle 400 and the target vehicle 401.

As an optional embodiment, the sensors of the host vehicle include a full range of heading angle of the target vehicle, heading angle data of the target vehicle can be obtained from the heading angle of the target vehicle, and the heading angle data of the host vehicle can be obtained from the sensor of the host vehicle itself. The present disclosure can obtain the vertical axis direction and horizontal axis direction of the independent coordinate through the heading angle data of the target vehicle and the heading angle data of the host vehicle.

At step S32, obtaining a relative longitudinal distance between the target vehicle track point and the host vehicle track point according to the independent coordinate.

As shown in FIG. 4, when the vertical axis direction X₂ of the independent coordinate (the direction from the host vehicle track point to the target vehicle track point) is not parallel to the vertical axis direction X₁ of the standard coordinate (the forward direction of the driving lane of the host vehicle 400), R₂ will be greater than R₁, R₂ is the distance between the target vehicle and the host vehicle obtained according to independent coordinates, and R₁ is the distance between the target vehicle and the host vehicle obtained according to the standard coordinates.

At step S33, obtaining the relative longitudinal velocity of the target vehicle at the target track point and the host vehicle at the host vehicle track point according to the independent coordinate.

As an optional embodiment, the longitudinal velocity of the host vehicle on the independent coordinates can be calculated first, and then the longitudinal velocity of the target vehicle on the independent coordinates can be calculated. Alternatively, the longitudinal velocity of the target vehicle on the independent coordinates can be calculated first, and then the longitudinal velocity of the host vehicle on the independent coordinates can be calculated. Finally, the relative longitudinal velocity is obtained according to the longitudinal velocity of the host vehicle and the longitudinal velocity of the target vehicle.

As an optional embodiment, the calculation method of the longitudinal velocity of the host vehicle includes: obtaining the first included angle between the driving direction of the host vehicle and the vertical axis of the independent coordinate, obtaining the driving velocity of the host vehicle, and obtaining the longitudinal velocity of the host vehicle according to the driving velocity of the host vehicle and the first included angle.

As an optional embodiment, the calculation method of the longitudinal velocity of the target vehicle includes: obtaining the second included angle between the driving direction of the target vehicle and the vertical axis of the independent coordinate, obtaining the driving velocity of the target vehicle, and obtaining the longitudinal velocity of the target vehicle according to the driving velocity of the target vehicle and the second included angle.

As shown in FIG. 4, when the vertical axis direction X₂ of the independent coordinate (the direction from the host vehicle track point to the target vehicle track point) is not parallel to the vertical axis direction X₁ of the standard coordinate (the forward direction of the driving lane of the host vehicle 400), V₂ will be less than V₁, V₂ is the relative longitudinal velocity obtained according to independent coordinates when the target vehicle 401 is at the target vehicle track point and the host vehicle 400 is at the host vehicle track point. V₁ is the relative longitudinal velocity obtained according to standard coordinates when the target vehicle is at the target vehicle track point and the host vehicle is at the host vehicle track point.

At step S34, calculating the projected collision time according to the relative longitudinal distance and the relative longitudinal velocity.

The projected collision time is equal to the relative longitudinal distance divided by the relative longitudinal velocity.

Compared with the technology of a learning process, the vertical coordinate of the independent coordinate is the direction of gradual approach between the host vehicle and the target vehicle, so the projected collision time calculated by the relative longitudinal distance and relative longitudinal velocity is more accurate, thus improving the accuracy of the target vehicle collision prediction results. More specifically, since the relative longitudinal distance of the independent coordinate is large, and the relative longitudinal velocity is small compared with the standard coordinate, the projected collision time herein calculated will be greater than the projected collision time calculated with the standard coordinate. That is,

$$\frac{{R}_{2}}{{V}_{2}} > \frac{{R}_{1}}{{V}_{1}} .$$

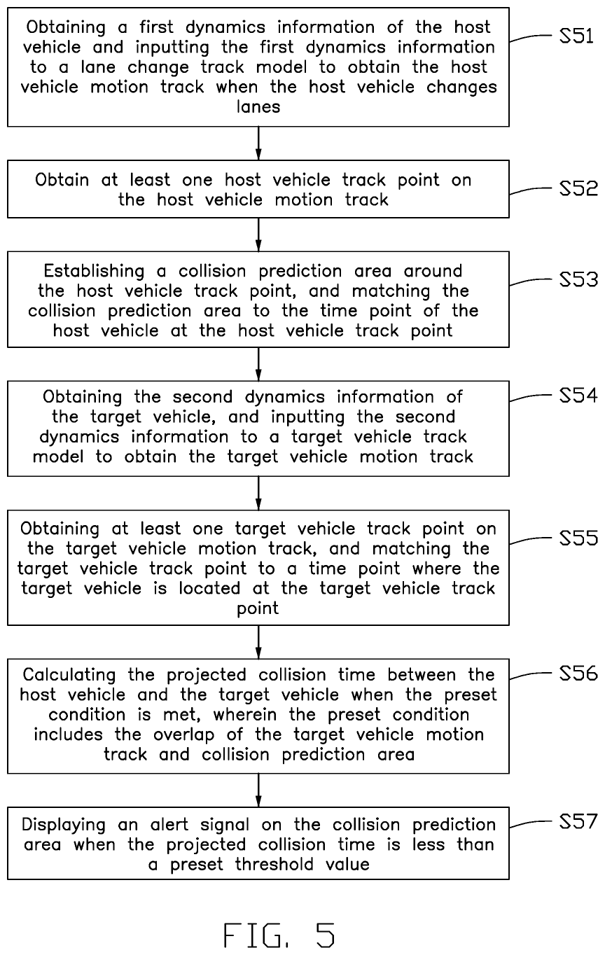

FIG. 5 illustrates a flowchart of a collision predicting method according to the embodiment of the present disclosure, which specifically includes the following steps:

At step S51, obtaining a first information as to dynamics of the host vehicle and inputting the first information to a lane change track model to obtain the host vehicle motion track when the host vehicle changes lanes.

As an optional embodiment, the first information includes the velocity, the acceleration and change in acceleration of the host vehicle, the formula of the lane change track model includes:

$${y}_{TAP} ( t ) = \{ \begin{matrix}\frac{1}{6} {J}_{y , d} {t}^{3} , for 0 \leq t \leq {t}_{1} \\ {y}_{1} + {v}_{1} ( t - {t}_{1} ) + \frac{1}{2} {{a}_{y , d} ( t - {t}_{1} )}^{2} , for {t}_{1} < t \leq {t}_{2} \\ {y}_{2} + {v}_{2} ( t - {t}_{2} ) + \frac{1}{2} {{a}_{y , 2 , d} ( t - {t}_{2} )}^{2} + \frac{1}{6} ( - {J}_{y , d} ) {( t - {t}_{2} )}^{3} , for {t}_{2} < t \leq {t}_{3} \\ {y}_{3} + {v}_{3} ( t - {t}_{3} ) + \frac{1}{2} ( - {a}_{y , d} ) {( t - {t}_{3} )}^{2} + \frac{1}{6} {{J}_{y , d} ( t - {t}_{3} )}^{3} , for {t}_{3} < t \leq {t}_{4} \\ {y}_{4} + {v}_{4} ( t - {t}_{4} ) + \frac{1}{2} ( - {a}_{y , d} ) {( t - {t}_{4} )}^{2} , for {t}_{4} < t \leq {t}_{5} \\ {y}_{5} + {v}_{5} ( t - {t}_{5} ) + \frac{1}{6} ( - {J}_{y , d} ) {( t - {t}_{5} )}^{3} , for {t}_{5} < t \leq {t}_{6} \\ {y}_{e v a} , for t > {t}_{6}\end{matrix} {x}_{TAP} ( t ) = v t$$

y_{TAP}(t) is the horizontal coordinate with the host vehicle as the origin during lane change. x_{TAP}(t) is the longitudinal coordinate; J_{y,d} is the jerk (i.e. lateral acceleration change rate), a_{y,d} is the acceleration of the host vehicle, yᵢ is the lateral distance at the time tᵢ, vᵢ is the velocity at the time tᵢ, yₑᵥₐ is the total lateral distance of lane change; v is the longitudinal velocity, t is the time. The use and meaning of the term “lateral” is already explained.

At step S52, obtain at least one host vehicle track point on the host vehicle motion track.

This step is consistent with step S22 above and will not be repeated here.

At step S53, establishing a collision prediction area around the host vehicle track point, and matching the collision prediction area with the time point of the host vehicle at the host vehicle track point.

This step is consistent with step S23 above and will not be repeated here.

At step S54, obtaining the second information as to dynamics of the target vehicle, and inputting the second information to a target vehicle track model to obtain the target vehicle motion track.

As an optional embodiment, the second information includes the velocity and the acceleration of the target vehicle. The calculation formula of the target vehicle track model includes:

$$[ \begin{matrix}{\hat{X}}_{k + 1} \\ {\hat{Y}}_{k + 1} \\ {\hat{V}}_{x , k + 1} \\ {\hat{V}}_{y , k + 1} \\ {\hat{a}}_{x , k + 1}\end{matrix} ] = [ \begin{matrix}1 & 0 & T & 0 & 0.5 {T}^{2} \\ 0 & 1 & 0 & T & 0 \\ 0 & 0 & 1 & 0 & T \\ 0 & 0 & 0 & 1 & 0 \\ 0 & 0 & 0 & 0 & 1\end{matrix} ] [ \begin{matrix}{\hat{X}}_{k} \\ {\hat{Y}}_{k} \\ {\hat{V}}_{x , k} \\ {\hat{V}}_{y , k} \\ {\hat{a}}_{x , k}\end{matrix} ]$$

\hat{X}ₖ is the horizontal coordinate at the time k, Ŷₖ is the longitudinal coordinate at the time k, \hat{V}_{y,k} is the longitudinal velocity at the time k, â_{x,k} is the lateral acceleration at time k, T is the time, \hat{X}ₖ₊₁ is the horizontal coordinate at the time k+1, Ŷₖ₊₁ is the longitudinal coordinate at the time k+1, \hat{V}_{x,k+1} is the lateral velocity at the time k+1, \hat{V}_{y,k+1} is the longitudinal velocity at the time k+1, â_{x,k+1} is the lateral acceleration at the time k+1.

At step S55, obtaining at least one target vehicle track point on the target vehicle motion track, and matching the target vehicle track point with a time point where the target vehicle will be located at the target vehicle track point.

This step is consistent with step S25 above and will not be repeated here.

At step S56, calculating a projected collision time between the host vehicle and the target vehicle when the preset condition is met, wherein the preset condition is an overlapping of the target vehicle motion track and collision prediction area.

This step is consistent with step S26 above and will not be repeated here.

At step S57, displaying an alert signal on the collision prediction area when the projected collision time is less than a preset threshold value.

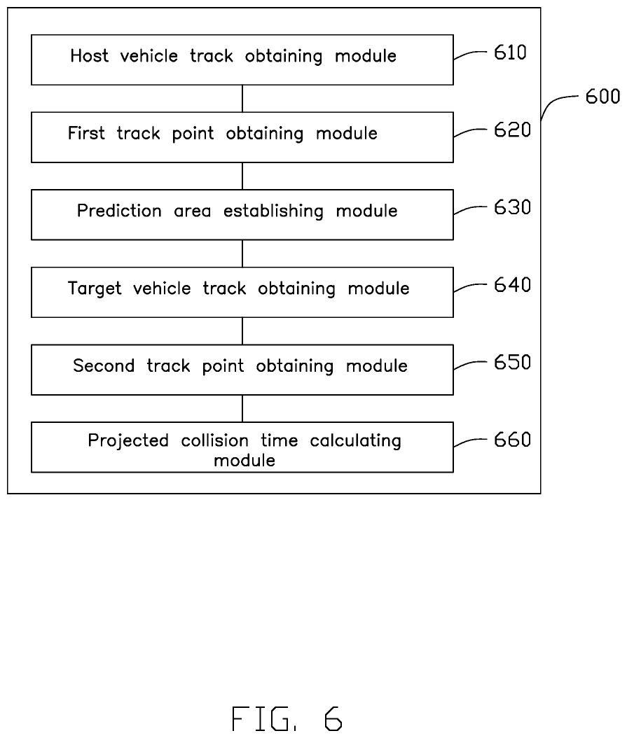

FIG. 6 illustrates a flowchart of a collision predicting device according to the embodiment of the present disclosure.

The collision predicting device 600 includes a host vehicle track obtaining module 610, a first track point obtaining module 620, a prediction area establishing module 630, a target vehicle track obtaining module 640, a second track point obtaining module 650, and a projected collision time calculating module 660.

The host vehicle track obtaining module 610 obtains the host vehicle motion track of the host vehicle.

The first track point obtaining module 620 obtains at least one host vehicle track point on the host vehicle motion track.

The prediction area establishing module 630 establishes a collision prediction area around the host vehicle track point, and matches the collision prediction area with the time point when the host vehicle will be located at the host vehicle track point.

The target vehicle track obtaining module 640 obtains the target vehicle motion track of the target vehicle.

The second track point obtaining module 650 obtains at least one target vehicle track point on the target vehicle motion track, and matches the target vehicle track point with a time point when the target vehicle will be located at the target vehicle track point.

The projected collision time calculating module 660 calculates the projected collision time between the host vehicle and the target vehicle when the preset condition is met, wherein the preset condition is the existence of an overlap between the target vehicle motion track and collision prediction area.

In the embodiments of the present disclosure, more detailed functional descriptions of the above modules can refer to the contents of the corresponding parts of the above embodiments, and will not be repeated here.

The embodiment of the present disclosure further provides a computer storage medium, which stores a computer program. When the computer program is executed by a processor, the processor executes the above collision predicting method. If a component module of the above collision predicting device is realized in the form of a software functional unit and sold or used as an independent product, it can be stored in the storage medium.

The above embodiments of method may be implemented in whole or in part by software, hardware, firm ware, or any combination thereof. When implemented by software, it can be implemented in the form of computer program products in whole or in part. The computer program product includes one or more computer instructions. When the computer program instructions are loaded and executed on a computer, the processes or functions described in the embodiments of the present disclosure are generated in whole or in part. The computer can be a general computer, a special computer, a computer network, or other programmable devices. The computer instructions can be stored in or transmitted through the computer readable storage medium. The computer instructions can be transmitted from a website, computer, server or data center to another website, computer, server, or data center wirelessly (such as infrared, wireless, microwave, etc.) or by wires (such as coaxial cable, optical fiber, digital subscriber line (DSL)). The computer-readable storage medium can be any available media that can be accessed by a computer or a data storage device including a server, a data center, and the like integrated with one or more available media. The available media can be magnetic media (for example, floppy disk, hard disk, magnetic tape), optical media (for example, digital Versatile Disc, DVD), or semiconductor media (for example, solid state disk, SSD).

Those skilled in the art can understand that all or part of the processes in the above embodiment method can be realized by instructing relevant hardware through a computer program, which can be stored in a computer readable storage medium. When the program is executed, it can include the flow of steps of embodiments of the above method. The storage medium includes ROM, RAM, disk or optical disc and other media that can store program code. In the case of no conflict, the technical features in the embodiment can be combined at will.

Those of ordinary skill in the art should realize that the above embodiments are only used to illustrate the present disclosure, but not to limit the present disclosure. As long as they are within the essential spirit of the present disclosure, the above embodiments are appropriately made and changes will fall within the scope of protection of the present disclosure.

What is claimed is:

1. A collision predicting method comprising:
obtaining a host vehicle motion track of a host vehicle;
obtaining at least one host vehicle track point on the host vehicle motion track;
establishing a collision prediction area around the at least one host vehicle track point, and matching the collision prediction area to a time point where the host vehicle is projected to be at the at least one host vehicle track point;
obtaining a target vehicle motion track of a target vehicle;
obtaining at least one target vehicle track point on the target vehicle motion track, and matching the at least one target vehicle track point to a time point where the target vehicle is projected to be at the at least one target vehicle track point; and
calculating a projected collision time between the host vehicle and the target vehicle when a preset condition is met; wherein the preset condition comprises an overlap of the target vehicle motion track and the collision prediction area.

2. The collision predicting method of claim 1, wherein the preset condition further comprises that the time point of the at least one target vehicle track point is same as the time point of the collision prediction area, and the target vehicle track point is located in the collision prediction area.

3. The collision predicting method of claim 1, wherein calculating a projected collision time between the host vehicle and the target vehicle comprises:
setting an independent coordinate; wherein a direction from the at least one host vehicle track point to the at least one target vehicle track point is a vertical axis direction of the independent coordinate;
obtaining a relative longitudinal distance between the at least one target vehicle track point and the at least one host vehicle track point according to the independent coordinate;
obtaining a relative longitudinal velocity between the target vehicle at the at least one target vehicle track point and the host vehicle at the at least one host vehicle track point according to the independent coordinate; and
calculating the projected collision time according to the relative longitudinal distance and the relative longitudinal velocity.

4. The collision predicting method of claim 1, wherein obtaining a host vehicle motion track of a host vehicle comprises:
obtaining a first information of the host vehicle and inputting the first information to a lane change track model when the host vehicle changes lanes, to obtain the host vehicle motion track.

5. The collision predicting method of claim 4, wherein the first information comprises a velocity of the host vehicle, an acceleration of the host vehicle; and a jerk of the host vehicle, a formula of the lane change track model comprises:
$${y}_{TAP} ( t ) = \{ \begin{matrix}\frac{1}{6} {J}_{y , d} {t}^{3} , for 0 \leq t \leq {t}_{1} \\ {y}_{1} + {v}_{1} ( t - {t}_{1} ) + \frac{1}{2} {{a}_{y , d} ( t - {t}_{1} )}^{2} , for {t}_{1} < t \leq {t}_{2} \\ {y}_{2} + {v}_{2} ( t - {t}_{2} ) + \frac{1}{2} {{a}_{y , 2 , d} ( t - {t}_{2} )}^{2} + \frac{1}{6} ( - {J}_{y , d} ) {( t - {t}_{2} )}^{3} , for {t}_{2} < t \leq {t}_{3} \\ {y}_{3} + {v}_{3} ( t - {t}_{3} ) + \frac{1}{2} ( - {a}_{y , d} ) {( t - {t}_{3} )}^{2} + \frac{1}{6} {{J}_{y , d} ( t - {t}_{3} )}^{3} , for {t}_{3} < t \leq {t}_{4} \\ {y}_{4} + {v}_{4} ( t - {t}_{4} ) + \frac{1}{2} ( - {a}_{y , d} ) {( t - {t}_{4} )}^{2} , for {t}_{4} < t \leq {t}_{5} \\ {y}_{5} + {v}_{5} ( t - {t}_{5} ) + \frac{1}{6} ( - {J}_{y , d} ) {( t - {t}_{5} )}^{3} , for {t}_{5} < t \leq {t}_{6} \\ {y}_{e v a} , for t > {t}_{6}\end{matrix}$$
x_{TAP}(t)=vt, wherein
y_{TAP}(t) is a horizontal coordinate wherein the host vehicle is an origin during lane change,
x_{TAP}(t) is a longitudinal coordinate,
J_{y,d} is a lateral jerk of the host vehicle,
a_{y,d} is an acceleration of the host vehicle,
yᵢ is a lateral distance at time tᵢ,
vᵢ is velocity at time tᵢ,
yₑᵥₐ is a total lateral distance of the lane change,
v is a longitudinal velocity of the host vehicle, and
t is a time point.

6. The collision predicting method of claim 1, wherein obtaining a target vehicle motion track of a target vehicle comprises:
obtaining a second information of the target vehicle and inputting the second information to a target vehicle track model to obtain the target vehicle motion track.

7. The collision predicting method of claim 6, wherein the second information comprises a velocity of the target vehicle, and an acceleration of the target vehicle, a formula of the target vehicle track model comprises:
$$[ \begin{matrix}{\hat{X}}_{k + 1} \\ {\hat{Y}}_{k + 1} \\ {\hat{V}}_{x , k + 1} \\ {\hat{V}}_{y , k + 1} \\ {\hat{a}}_{x , k + 1}\end{matrix} ] = [ \begin{matrix}1 & 0 & T & 0 & 0.5 {T}^{2} \\ 0 & 1 & 0 & T & 0 \\ 0 & 0 & 1 & 0 & T \\ 0 & 0 & 0 & 1 & 0 \\ 0 & 0 & 0 & 0 & 1\end{matrix} ] [ \begin{matrix}{\hat{X}}_{k} \\ {\hat{Y}}_{k} \\ {\hat{V}}_{x , k} \\ {\hat{V}}_{y , k} \\ {\hat{a}}_{x , k}\end{matrix} ] ,$$
wherein
\hat{X}ₖ is a horizontal coordinate at a time k,
Ŷₖ is a longitudinal coordinate at the time k,
\hat{V}_{y,k} is a longitudinal velocity at the time k,
â_{x,k} is a lateral acceleration at the time k,
T is a time point,
\hat{X}ₖ₊₁ is a horizontal coordinate at a time k+1,
Ŷₖ₊₁ is a longitudinal coordinate at the time k+1,
\hat{V}_{x,k+1} is a lateral velocity at the time k+1,
\hat{V}_{y,k+1} is a longitudinal velocity at the time k+1,
â_{x,k+1} is a lateral acceleration at a time k+1.

8. The collision predicting method of claim 1, further comprising:
displaying an alert signal on the collision prediction area when the projected collision time is less than a preset threshold value.

9. A collision predicting device comprising:
a host vehicle track obtaining module configured for obtaining a host vehicle motion track of a host vehicle;
a track point obtaining module configured for obtaining at least one host vehicle track point on the host vehicle motion track;
a prediction area establishing module configured for establishing a collision prediction area around the host vehicle track point, and matching the collision prediction area to a time point where the host vehicle is located at the host vehicle track point;
a target vehicle track obtaining module configured for obtaining a target vehicle motion track of a target vehicle;
a second track point obtaining module configured for obtaining at least one target vehicle track point on the target vehicle motion track, and matching the target vehicle track point to a time point where the target vehicle is located at the target vehicle track point; and
a projected collision time calculating module configured for calculating a projected collision time between the host vehicle and the target vehicle when a preset condition is met; wherein the preset condition comprises an overlap of the target vehicle motion track and the collision prediction area.

10. A non-transitory storage medium having stored thereon instructions that, when executed by a processor, causes the processor to perform a collision predicting method, wherein the method comprises:
obtaining a host vehicle motion track of a host vehicle;
obtaining at least one host vehicle track point on the host vehicle motion track;
establishing a collision prediction area around the at least one host vehicle track point, and
matching the collision prediction area to a time point where the host vehicle is projected to be at the at least one host vehicle track point;
obtaining a target vehicle motion track of a target vehicle;
obtaining at least one target vehicle track point on the target vehicle motion track, and matching the at least one target vehicle track point to a time point where the target vehicle is projected to be at the at least one target vehicle track point; and
calculating a projected collision time between the host vehicle and the target vehicle when a preset condition is met; wherein the preset condition comprises an overlap of the target vehicle motion track and the collision prediction area.

11. The non-transitory storage medium of claim 10, wherein the preset condition further comprises that the time point of the at least one target vehicle track point is same as the time point of the collision prediction area, and the target vehicle track point is located in the collision prediction area.

12. The non-transitory storage medium of claim 10, wherein calculating a projected collision time between the host vehicle and the target vehicle, comprises:
setting an independent coordinate; wherein a direction from the at least one host vehicle track point to the at least one target vehicle track point is a vertical axis direction of the independent coordinate;
obtaining a relative longitudinal distance between the target vehicle track point and the at least one host vehicle track point according to the independent coordinate;
obtaining a relative longitudinal velocity of the target vehicle at the at least one target track point and the host vehicle at the at least one host vehicle track point according to the independent coordinate; and
calculating the projected collision time according to the relative longitudinal distance and the relative longitudinal velocity.

13. The non-transitory storage medium of claim 10, wherein obtaining a host vehicle motion track of a host vehicle, comprises:
obtaining a first information of the host vehicle and inputting the first information to a lane change track model when the host vehicle changes lanes, to obtain the host vehicle motion track.

14. The non-transitory storage medium of claim 13, wherein the first dynamic information comprises a velocity of the host vehicle, an acceleration of the host vehicle; and a jerk of the host vehicle, a formula of the lane change track model comprises:
$${y}_{TAP} ( t ) = \{ \begin{matrix}\frac{1}{6} {J}_{y , d} {t}^{3} , for 0 \leq t \leq {t}_{1} \\ {y}_{1} + {v}_{1} ( t - {t}_{1} ) + \frac{1}{2} {{a}_{y , d} ( t - {t}_{1} )}^{2} , for {t}_{1} < t \leq {t}_{2} \\ {y}_{2} + {v}_{2} ( t - {t}_{2} ) + \frac{1}{2} {{a}_{y , 2 , d} ( t - {t}_{2} )}^{2} + \frac{1}{6} ( - {J}_{y , d} ) {( t - {t}_{2} )}^{3} , for {t}_{2} < t \leq {t}_{3} \\ {y}_{3} + {v}_{3} ( t - {t}_{3} ) + \frac{1}{2} ( - {a}_{y , d} ) {( t - {t}_{3} )}^{2} + \frac{1}{6} {{J}_{y , d} ( t - {t}_{3} )}^{3} , for {t}_{3} < t \leq {t}_{4} \\ {y}_{4} + {v}_{4} ( t - {t}_{4} ) + \frac{1}{2} ( - {a}_{y , d} ) {( t - {t}_{4} )}^{2} , for {t}_{4} < t \leq {t}_{5} \\ {y}_{5} + {v}_{5} ( t - {t}_{5} ) + \frac{1}{6} ( - {J}_{y , d} ) {( t - {t}_{5} )}^{3} , for {t}_{5} < t \leq {t}_{6} \\ {y}_{e v a} , for t > {t}_{6}\end{matrix}$$
X_{TAP}(t)=vt, wherein
y_{TAP}(t) is a horizontal coordinate wherein the host vehicle is an origin during lane change,
x_{TAP}(t) is a longitudinal coordinate,
J_{y,d} is a lateral jerk of the host vehicle,
a_{y,d} is an acceleration of the host vehicle,
yᵢ is a lateral distance at time tᵢ, vᵢ is velocity at time tᵢ,
yₑᵥₐ is a total lateral distance of the lane change, and
v is a longitudinal velocity of the host vehicle, t is the time.

15. The non-transitory storage medium of claim 10, wherein obtaining a target vehicle motion track of a target vehicle, comprises:
obtaining a second information of the target vehicle and inputting the second information to a target vehicle track model to obtain the target vehicle motion track.

16. The non-transitory storage medium of claim 15, wherein the second dynamic information comprises a velocity of the target vehicle, and an acceleration of the target vehicle, a formula of the target vehicle track model comprises:
$$[ \begin{matrix}{\hat{X}}_{k + 1} \\ {\hat{Y}}_{k + 1} \\ {\hat{V}}_{x , k + 1} \\ {\hat{V}}_{y , k + 1} \\ {\hat{a}}_{x , k + 1}\end{matrix} ] = [ \begin{matrix}1 & 0 & T & 0 & 0.5 {T}^{2} \\ 0 & 1 & 0 & T & 0 \\ 0 & 0 & 1 & 0 & T \\ 0 & 0 & 0 & 1 & 0 \\ 0 & 0 & 0 & 0 & 1\end{matrix} ] [ \begin{matrix}{\hat{X}}_{k} \\ {\hat{Y}}_{k} \\ {\hat{V}}_{x , k} \\ {\hat{V}}_{y , k} \\ {\hat{a}}_{x , k}\end{matrix} ] ,$$
wherein
\hat{X}ₖ is a horizontal coordinate at a time k,
Ŷₖ is a longitudinal coordinate at the time k,
\hat{V}_{y,k} is a longitudinal velocity at the time k,
â_{x,k} is a lateral acceleration at the time k,
T is a time point,
\hat{X}ₖ₊₁ is a horizontal coordinate at a time k+1,
Ŷₖ₊₁ is the longitudinal coordinate at the time k+1,
\hat{V}_{x,k+1} is a lateral velocity at the time k+1,
\hat{V}_{y,k+1} is a longitudinal velocity at the time k+1, and
â_{x,k+1} is a lateral acceleration at a time k+1.

17. The non-transitory storage medium of claim 10, further comprising:
displaying an alert signal on the collision prediction area when the projected collision time is less than a preset threshold value.
